(19) United States
(12) Patent Application Publication
(10) Pub. No.: US 2009/0266465 A1
(43) Pub. Date: Oct. 29, 2009

(54) Universal run flat tire system and device

(76) Inventors: John M. Deslierres, Fullerton, CA (US); Maria R. Deslierres, Fullerton, CA (US); Julian Yee, Los Angeles, CA (US)

Correspondence Address: JOHN M. DESLIERRES, 2337 E. Brookdale Place, Fullerton, CA, 92831-3501, US

(21) Appl. No.: 12/150,125

(22) Filed: Apr. 24, 2008

(51) Int. Cl. B60C 17/04

(52) U.S. Cl. 152/517

(57) ABSTRACT

The universal system and device of the present invention, once inserted in a conventional pneumatic tire, allows the driven vehicle to be operated in a normal operating condition, as well as in both a low tire pressure and in a run flat condition. For such purpose the tire embodies this device, spherically shaped and not limited in size or quantity. The device is manufactured from rubber, neoprene or equivalent, and in various shore hardness as needed, to permit installation in all tire shapes and sizes, and can be accommodated on all standard or special vehicle rim sizes or configurations. The device is adaptable to automobile, trucks, motorcycles, bicycles or any vehicle that utilizes pneumatic tires and their various uses, including freeway driving, off road, snow and ice, and will adapt to any new configurations of tires and rims such as the low profile tires.

### BACKGROUND OF THE INVENTION

Pneumatic tires are utilized on all types of automobiles, trucks, motorcycles and bicycles. They come in all sizes and are adaptable to the many vehicles available for transportation of both people and commercial products throughout industry today. They generally are filled with pressurized air or nitrogen in order to provide a smooth ride, accommodate variations in road surfaces and are even used for business or pleasure and off road pursuits by the general public all over the world. These tires now in use are considered as tubeless tires and are designed and manufactured with a heavy tread that contacts the road bed surface and a majority of them are built with an inner steel belt over laid with plies of nylon or equivalent liners that cross over the full width of the tire and down its sides and fold into a bead that seals against the vehicles external wheel rim. The plies are molded into the tires tread and bead to secure the many layers in place and provide a solid member to apply pressure on the rim flange that captures the tire and provides a means for sealing it against the rim and prevent escape of the pressurized air that inflated the tire.

All of these vehicles require pneumatic tires and replacement tires due to wear, life and damaging use encountered in their operational existence. One of the problems they all encounter is inadvertent puncture by road debris, glass, nails and like means for receiving punctures. Once a tire is punctured by such an object the pressurized air escapes and the tire goes flat and cannot be operated as such or receives irreparable damage to the tire and possibility the wheel rim. This condition is called a run flat condition and often tires in this condition cause dangerous accidents and addressed by inventors for some time and all the inventions in this category seek a method, a means or a modification to the vehicles tire, the vehicles rim or an embodiment that utilizes either or both to achieve a run flat condition for the vehicle. There have been a number of patents that address this run flat problem as noted in the following patents:

U.S. Pat. No. 5,634,993 DRIEUX for “rim and assembly of a tire and ring shaped tread support on same.” This invention applies to modification of both the tire carcass, the wheel rim and adds a tread support ring full around the inside of the tire. This patent pertains to modification of both the tire carcass, the rim and installs a full around support ring and does not apply to the present submitted invention.

U.S. Pat. No. 5,660,653 GARDETTO for “run flat support for pneumatic tire wheel.” This invention addresses the run flat condition by attachment of a radially extending and retracting support device mounted to the wheel rim rectangular in shape that bears against the tire beads and the rim to provide a box section to support the punctured tire when it goes flat. This patent does not apply to the present invention.

U.S. Pat. No. 5,868,190 WILLARD et al for “run flat tire with an improved bead to rim interface.” This invention applies a belt package with a plurality of radially reinforced layers of belt plies molded into the interior surfaces of the tire and its tread to support the vehicle on a tire that has been punctured and runs flat. The additional carcass layers stiffen the tire during loss of pressure. This patent modifies the tire carcass and does not apply to the present submitted invention.

U.S. Pat. No. 5,891,279 LACOUR, for “safety support made of a flexible electrometric material for tires”. This invention installs a circular tire within the carcass of the tire on the wheel rim to provide a means that can support the vehicle when the tire is punctured, loses pressure and runs flat. As the wheel rim is modified to support and capture the internal tire assemblage, this patent does not apply to the present invention.

U.S. Pat. No. 6,116,308 YOSHIDA, for “run flat tire system”. This invention applies to a run flat tire system having a molded annular core body installed in the tire assembly on a wheel of a motorcycle. The core molded to the shape of the tire's internal envelope applies pressure on the tires casing, tread and beads as a solid backup internally to accept running loads against the tires sidewalls and treads experienced by a motorcycle. The core is molded to the inner shape of the tire; hence, this patent does not apply to the present submitted invention.

U.S. Pat. No. 6,321,808 B1 SPRAGG et al for “an expandable band for run flat tire and method of making a tire,” address this condition by making major changes to the tire. This invention applies to the manufacture of a tire by inserting in the tire molding process a series of reinforcing fabric bands and metal bands inserted into the fabric bands for the purpose of applying pressure to the tires carcass to protect the tires sidewalls, treads and beads and prevent the tire from collapsing and going flat with loss of pressure. This patent does not apply to the present submitted invention.

U.S. Pat. No. 6,516,845 B2 NGYEN et al addresses “a support device within a tire cavity to provide run flat capability.” This invention provides a modification to the wheel rim as an annular structure having a box section attached to the rim that contains an attachment to its perimeter of three annular tubes welded to each other and to the welded rim for the purpose of preventing the tire carcass from collapsing and loss of pressure providing a means for the tire to bear against the tubes to support it in the run flat condition. This patent does not apply to the present submitted invention.

U.S. Pat. No. 6,543,502 B2 OHURA addresses “pneumatic tires having sidewall, reinforcing rubber and bead reinforcing layer” provides the manufacturing process for installing beads, cores, fillers, cords and rubber in the development of the molding process. These items reinforce the tire and its sidewalls as the tire carcass is formed to improve the beading that bears against the wheel rim. This patent does not apply to the present invention.

U.S. Pat. No. 7,331,639 B2 OKAJIMA addresses “bicycle rim” and provides for the manufacture of the wheels rim and spokes of the bicycle. The invention explains how the plurality rim reinforcements and tire can be mounted to the wheel rim. The patent also provides for the application of adhesive to the rim and the tire as it is installed on the bicycle rim. This patent does not apply to the submitted invention.

U.S. Pat. No. 6,668,884 B2 KOCH et al provides “a combination tire and monitoring device.” The sensor that monitors the tire condition and pressure is bonded directly to the inner liner of the tire in several locations such as the tire bead, tire tread to inform the driver that the tire is about to go flat. The solution presented by this patent does not apply to the present invention.

U.S. Pat. No. 6,814,114 B2 BOUVIER et al for “tire to rim rotation limiter for a run flat assembly.” This patent provides a means to inhibit a tire from rotating on the wheel rim. This condition occurs under high speed running during turns and skidding when the vehicle is operated during periods of low and normal tire pressure. This patent prevents this rotation movement by engaging beads, slots and indentations in the wheel to stop rotation of the tire relative to the rim, hence, does not apply to the present submitted invention.

The present invention improves upon previous run flat tire configurations in that it can be applied to standard tires and rims, while the previous known run flat configurations require modifications to basic tires and rims, in addition to a number of disadvantages, as follows:
(a) DRIEUX requires major changes to tire beads and tread to prevent loss of tire pressure that causes tire deflation and can lead to serious accidents;
(b) GARETTO and NGYEN et al both require that the vehicle's wheel rim must be modified to provide structure to support the vehicle when the tire collapses;
(c) WILLARD et al require that the tire must be modified to provide a plurality of radially reinforced layers of belt plies to the interior of the tire's sidewalls and tire's treads;
(d) LACOUR requires a tire installed within a tire to accept a run flat condition;
(e) YOSHIDA requires that the tire must contain an additional solid backup core to accept the run flat condition;
(f) SPRAGG et al requires that the tire must be redesigned and changed to mold in additional metal bands to prevent collapse of the tire;
(g) KOCH et al provides sensors that require the tire to be modified and sensors must be added to the tire manufacture to inform the vehicle driver the probable is about to occur;
h) BOUVIER et al requires that the tire and rim must be modified to contain special interface connections and variations to engage with each other and operate in a run flat condition;

Considering the objectives and disadvantages discussed above in the various previous patents, the following objects and advantages of the present invention are:
A) An universal system and device that reinforces the tire tread and sidewalls during normal running conditions.
B) An universal system and device that permits the tire to be punctured and provides a means for the tire to run in a run flat condition.
C) An universal system and device that can support the vehicle on a tire that can run on low pressure, no pressure or a run flat condition.
D) An universal system and device that can still apply pressure and seal the tire bead against the vehicle's rim flange on a punctured pneumatic tire.
E) An universal system and device that when installed on a vehicle's steering wheel tires inhibits loss of control of the vehicle in a blow out tire condition.
F) An universal system and device that can be installed on all types of tires, rims and all vehicles that use pneumatic tires.

This invention provides a means for utilization of an universal run flat tire system and device that can be applied and installed on all vehicles that use pneumatic tires

The herein submitted invention for run flat tire device improves upon previous run flat tire configurations in that it can be applied to standard tires and rims while the previous known run flat configurations require modifications to basic tires and rims and suffer from a number of disadvantages, as follows:
a) a loss of tire pressure causes tire deflation and tire carcass distortion, and can lead to serious accidents;
b) to avoid loss of tire pressure, the tire must be modified by the manufacturer to accommodate the run flat condition;
c) on several previous inventions, the wheel and tire must be modified to accept run flat supporting structure and adapters;
d) on several previous inventions, the tire must be modified to provide a plurality of reinforced layers and belt plies to the tires tread and sidewalls;
e) the tire must be redesigned and changed to mold in additional metal bands to prevent collapse of the tire;
f) the tire and rim must be modified to contain special interface connections, recess cavities and variations to engage each other and operate in a run flat condition;
g) the tire must contain an additional solid backup core and must match the internal tire envelope to accept a run flat condition;

We have noted above the objects and disadvantages of the various previous patents.

Here are the objects and advantages of the present submitted patent:
A) The present invention provides run flat tire capability to any pneumatic tire utilized on any type of automobile, truck, motorcycle or bicycle;
B) this invention does not require special matching rims;
C) this invention can accommodate any tire shape or configuration;
D) this invention does not need to be molded to any special tire or rim shape;
E) this invention is adaptable to any new or special innovations of tire design such as low profile tires;
F) this invention can be easily installed in any tire configuration;
G) this invention can operate and support any run flat or partial loss of tire pressure condition;
H) this invention can be readily manufactured and has no limitations on size, diameters or applications and can be reused if needed or desired;
I) this invention can be applied to small diameter tires such as motorcycle and inflatable bicycle tires as well as off road tires, snow and ice tires, and special low profile tires;
J) this invention reinforces the tire tread and sidewalls during normal running conditions;.
K) this invention permits the tire to be punctured and provides a means for the tire to run in a run flat condition;
L) this invention can support the vehicle weight on a tire that can run on a low pressure, no pressure or a run flat condition.
M) this invention can still apply pressure and seal the tire bead against the vehicle's rim. flange on a punctured pneumatic tire.
N) this invention when installed on the vehicle's wheels provides the steering wheels with the capability to inhibit loss of control of the vehicle in a blow out tire condition;
O) this invention can be installed on all types of tires, rims and all vehicles that use pneumatic tires.

As stated above, this invention provides a means for utilization of an universal run flat tire system and device that can be applied and installed on all vehicles that use pneumatic tires, independent of weight, size, cross section shape, tread, usages, brand names, etc.

### BRIEF SUMMARY OF THE INVENTION

This invention provides a means for inserting into the tire at any time, when it is new or after some use, an universal system and device that permits the tire, even when it is punctured, to continue to support the vehicle in a run flat condition. It allows the tire to remain functional and not go entirely flat with loss of pressure, and permits it to run and operate even in snow and ice conditions and in a multiplicity of road incursions that vehicles, motorcycles, and trucks of various sizes encounter in every day occurrences and accidents.

The system and device of this invention encompasses a series of spherical balls of various spherical diameters, size, that are rubber, neoprene or equivalent that can be inserted into the tire either before installation on a wheel rim or after the tire is installed on the rim. The spherical balls fill the tire carcass and transfer the vehicle load to the wheel rim when the tire is punctured or when the tire pressure is low or partially lost. The spherical balls can fit in any tire of any size or shape and can mesh with any vehicle wheel rim that is standard or special. The spherical balls can support the vehicle weight and provide a means to keep the tire carcass from getting overly deflated or damaged with loss of pressure in a run flat operating condition. This device is adaptable to large or small tires, the size of the spherical diameter balls is not limited and can be manufactured in various diameters and shore hardness to accommodate all pneumatic tires on all types of vehicles from automobiles, to trucks, motorcycles, bicycles, trailers, other adaptations and even pneumatic tires on private or commercial airplanes.

In all configurations the invention's system and device function and operate as a viable means for providing a run flat solution to pneumatic tires of all sizes and configurations. It can accommodate even off road vehicles, snow and ice tires, small or low cross section tires and motorcycles that when installed can transfer vehicle support loads to both the tread and the sidewalls of the tire due to cornering and turning. This invention provides an economical solution and a practical means for achieving and solving a run flat condition.

### BRIEF DESCRIPTION OF THE DRAWINGS

FIG. 1 Shows a cross section view of the invention installed in a tire mounted on the wheel of a vehicle or mid-sized truck. This view shows how the Run Flat Tire System and Device provides reinforcement to the tread, the sidewalls and provides pressure on the tires beads to ensure they seal and hold the air or nitrogen within the tire and provides it run flat capability.

FIG. 2 Shows a cross section view of the invention installed in a low profile tire on an automobile and illustrates how the Run Flat Tire System and Device provides support to the tire casing in a run flat condition.

FIG. 3 Shows a cross section view of the invention installed in a tire mounted on the wheel of a motorcycle. This view shows how the Run Flat Tire System and Device provides reinforcement to the tread, the sidewalls and provides pressure on the tires beads to ensure they seal and hold pressure within the tire and provides it with run flat capability.

FIG. 4 Shows a cross section view of the invention installed in a tire mounted on the wheel of a bicycle. The view shows how the Run Flat Tire System and Device can be adapted to a bicycle tire and provides the equal and same advantages for the bicycle to permit operation of the bicycle when the tire contains low pressure, no pressure as a result of a puncture and adds a run flat capability to the bicycle.

### DETAILED DESCRIPTION OF THE INVENTION

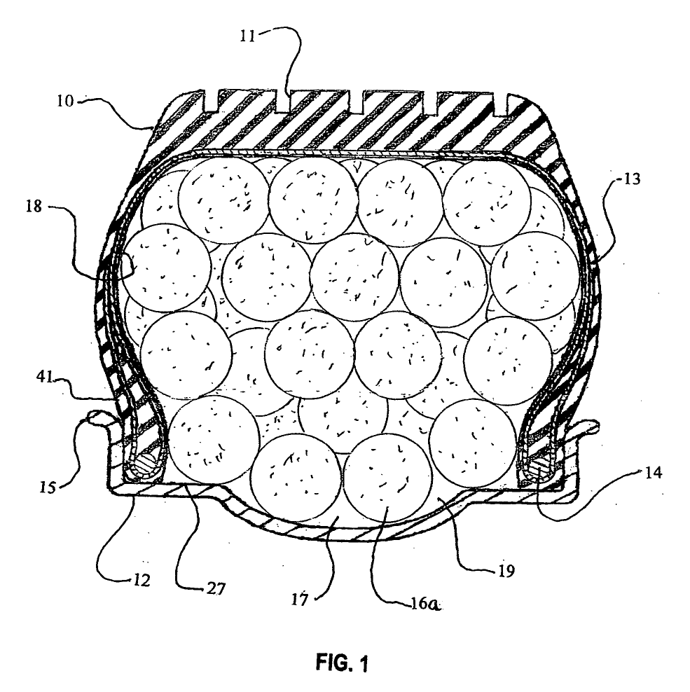

Reference will now be made in detail to embodiments of the invention, one or more examples of which are illustrated in the drawings. Each example provided by way of explanation of the invention, and not meant as a limitation of the invention. For example, features illustrated or described as part of one embodiment can be used with another embodiment to yield still a third embodiment. It is intended that the present invention include these and other modifications and variations. A typical embodiment of this invention is illustrated in FIG. 1 cross section view. This shows a conventional pneumatic tire (10) that is air or nitrogen (17) filled on a standard automobile or truck wheel rim (12). Installed in this said standard tire and wheel rim are spherical shaped balls (16a) that when the tire casing (41) is filled with them and receives a puncture and the said air or nitrogen (17) escapes, the said spherical balls support the tire tread (11) and tire sidewalls (13) and inhibit the said tire from collapsing and provide the tire a means for running in a run flat condition.

When the said tire is filled with the said balls, they do not prevent the said tire from being filled with the said air or nitrogen and do not prevent the said tire from being operated in a normal running condition. As the said balls fill the said tire and bear against each other and bear against the inside of the said tire and contact and bear against the said tire, they reinforce both the said tread and the said sidewalls at point of contact (18). Should the said tire receive a puncture, said points of contact restrain the said tire from collapsing and provide the said tire a means to run in a run flat condition.

In addition, on tire puncture, when the said balls of this invention system and device experience the load of the vehicle, their pressure against each other, against the tire casing (41) and against the said vehicle tire rim, distribute and applies pressure against the said casing and the tire bead (14) and, in turn, force the said bead against the said rim and the rim flange (15). The invention's feature of this embodiment using a multiplicity of said spherical balls of diameters and shore hardness as needed for standard or special tires permits the run flat condition to distribute and share the load through the multiplicity of balls and accommodate and works with any said tire and said vehicle wheel rim. Said feature also provides control of a collapsing said tire casing conforming to any shape of said rim or tire. In addition, the tire rim cavity (19) can be filled with said balls without limitation of size or quantity. In all conditions the said balls provide ample multiple support to the said punctured tire and prevent it from escaping from the said rim and inhibits damage to the said tire casing. The invention provides the means for applying said point of contact to the said tire casing at a multiplicity of points. The said balls pressing against each other and pressing against the said tire casing tread, as well as the said sidewalls and said beads, ensures that the said tire maintains the same attitude, position and capability to continue to support the said tire in all operating conditions of low pressure or no air in the said tire or in the said run flat condition. The said spherical balls, pressing against the said tire bead, ensure that the said tire bead will seal against the vehicle's said rim upstanding flange or leg and the said balls will prevent the said punctured tire casing (41) from escaping from the said wheel rim and cause damage to the said tire or the said rim. Generally this damage is caused when the said tire on puncture begins to collapse and the vehicles weight shifts downward and crushes the unsupported said casing against the said metal rim and its said upstanding leg or flange.

One of the major causes of accidents is having a tire receive a blow-out at high or moderate speed on one of the vehicle's or truck's steering wheels. In this blow-out condition the tire casing is instantly crushed by the vehicles tire loss of pressure resulting in shifting of vehicle weight and center of gravity. As a result, the driver loses control of the vehicle and the accident occurs. This invention on blow-out keeps the said tire casing in an upright operating attitude, keeps pressure on the said tires bead against the said vehicle's upstanding rim flange and inhibits the said tire casing from crushing and being driven off the said wheel rim, and in this critical instance of the accident supports the vehicle weight and provides the driver with a means for maintaining control of the said vehicle while reducing speed. This invention is adaptable to any tire configuration, shape or size and is not restricted by either rim shape or tire shape. A distinct advantage of this system and device is that said balls can be provided with harder or softer shore hardness and size to meet any operational needs of very special tires and meet their intended use.

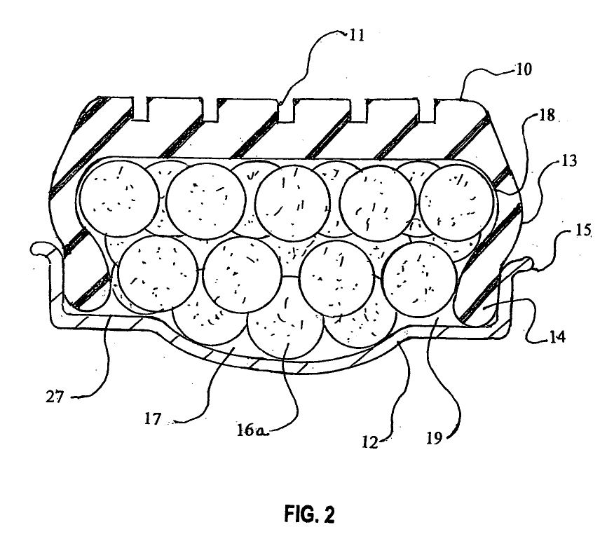

The invention provides the said vehicle's tire with a run flat capability without modification to the said standard tire or the said rim base (27) that supports the punctured collapsed run flat condition or any special tire such as snow tires, low profile tires and or any rim size configuration. FIG. 2 shows a cross section view of a typical low profile tire configuration on a said standard or common rim (12) with the said balls (16b) installed for accepting the run flat capability. It can be seen that the components of this system and device are the same for all configurations of tires and provide the same advantages that the invention brings to the said conventional standard tire. In fact, the said low profile tire is more susceptible to puncture and a run flat condition due to the rims' closeness to the running road surface, to the critical low operating pressure, to its softer ride and on cornering the tires susceptibility to side rotation and shifting movement on the turn. The said low profile tire needs the security and backup run flat capability of this invention system and device, because these said tires generally run in an exceptionally low pressure condition for the purpose of lowering the vehicle's CG and height off the ground.

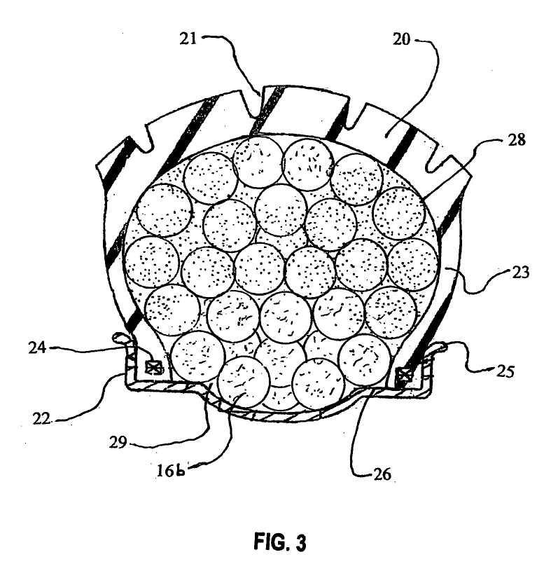

In fact, because of this versatility to adapt without change to any inflatable tire, the invention can function and provide the same advantages to motorcycles and bicycle tires. FIG. 3 shows a cross section view of the invention's system and device installed in a motorcycle tire (20). The said balls (16b) are of a mid size and smaller with shore hardness adapted to accommodate the motorcycle's smaller size tire and its operational requirements. The said balls provide the same advantages as the prior embodiment for cars and vehicles such as trailers with multiple tires, permitting contact to the underside of the said tire tread (21) and securely bearing against the said tread. This tread is generally curved for a motorcycle installed tire to permit the said tire to operate and partially ride on its motorcycle tire sidewalls (23) during turning and side skidding. The invention without change also provides support and supplies many points of contact (28) to the said motorcycle tires. Said sidewalls receive support around the full envelope, and the invention's device, in turn, continues to apply both contact and outward pressure against the internal side of the tire beads (24) of the motorcycle and maintains pressure to ensure sealing of the said beads against the wheel rim (22) and the rim flange (25). The multiplicity of said pressure points provided by the said balls maintains the tire carcass (41) in an upright attitude and functional position to ensure the said motorcycle tire can operate and continue to run whether it is partially inflated or is in the run flat condition. Inasmuch as the said motorcycle tire is smaller in cross section than said automobile tire, the motorcycle tire cavity (29) functions in like manner as said automobile tire. Said balls fill the said motorcycle tire cavity and support the collapsed said tire on the motorcycle rim base (26) in that run flat condition. The said motorcycle tire can be filled with the said air or nitrogen easily with the said run flat balls installed.

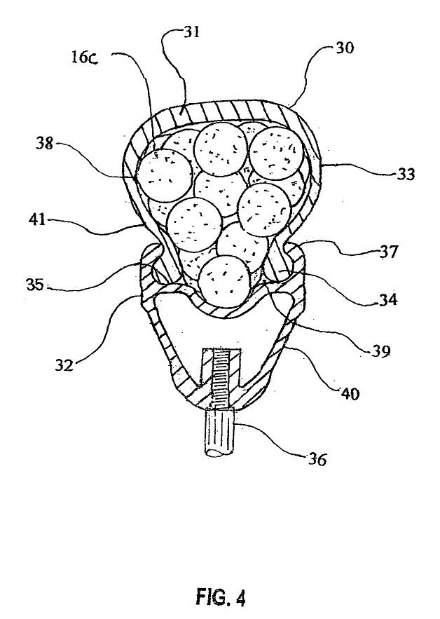

The invention system and device is also adaptable to any sized tire or tire shape or any rim configuration, including bicycles that can also encounter punctured tires, and the danger of operating in a run flat condition is then minimized. FIG. 4 provides a cross section view of a typical bicycle tire (30), rim (32), and tire casing configuration (41). This view shows how the invention can be applied to the many types of said bicycle tires and said rims available. The balls (16c) of a smaller size but of the same configuration, apply the same advantages to the said bicycle tire and its tread (31) and the said rims. The sidewalls beads (34) are reinforced by the said balls and the said balls apply a multiplicity of said pressure points on the bicycle tire sidewalls (33) and said beads to ensure said tire sealing and should the said tire become punctured, the said run flat invention's balls maintain the punctured tire on the said wheel rim and provide it total run flat capability with all the same advantages as the prior embodiments shown. The invention applies pressure and points of contact (38) against the said bicycle tire beads and forces these said beads tightly against the said rim and its rim flange (35). The addition of these said run flat devices does not affect the bicycles wheel spoke (36) attachment or installation. The bicycle's rim frame (37) and its structural cavity (40) are maintained without change and the cavities (39) formed by the said rim and said tire are not modified or compromised by the addition of the device of this invention. The installation of the standard bicycle tire or a special tire on the vehicle wheel is not modified or changed, no matter whether they are installed dry or wet with an adhesive applied to ensure sealing. The addition of this Run Flat Tire System capability to the bicycle provides safety and long life to the bicycle and its rider.

### LIST OF PARTS

10 Tire automobile, truck
11 Tire tread
12 Rim
13 Tire sidewalls
14 Tire bead
15 Rim flange
16a Spherical balls large
16b Spherical ball medium
16c Spherical balls small
17 Air or nitrogen
18 Point of contract
19 Cavity
20 Tire of motorcycle
21 Tire tread of motorcycle
22 Rim of motorcycle
23 Tire sidewalls of motorcycle
24 Tire bead of motorcycle
25 Tire rim of motorcycle
26 Rim base of motorcycle
27 Rim base of automobile
27 Rim base of automobile
28 Point of contact motorcycle
29 Cavity of motorcycle
30 Tire of bicycle
31 Tire tread of bicycle
32 Rim of bicycle tire
33 Tire sidewall of bicycle
34 Tire bead of bicycle
35 Rim base of bicycle
36 Wheel spoke of bicycle
37 Rim flange of bicycle
38 Point of contact bicycle
39 Cavity of bicycle
40 Frame of cavity of bicycle
41 Tire casing

We claim;

A. An universal run flat tire system and device installed in a vehicle's pneumatic tire for running the tire in the run flat condition;
a) a system and device that reinforce and supports the tire tread in normal running conditions,
b) a system and device that reinforce the tire sidewalls in normal running conditions,
c) a system and device that provide a means for the tire, once punctured, to run in a run flat condition,
d) a system and device that can support the vehicle and run on a low pressure, no pressure, or run flat punctured tire,
e) a system and device that have provisions for resting on the vehicle rim and can apply pressure and seal the tire bead against the vehicle rim flange on a punctured tire,
f) a system and device that prevent the tire casing from unsealing and escaping off the tire rim in a run flat condition,
g) a system and device adaptable to low profile tires to run in a run flat condition,
h) a system and device that when installed in the vehicle's steering wheel tires inhibit loss of control of the vehicle on a blow out tire condition,
i) a system and device that provide additional safety to the driver of all vehicles using pneumatic tires.

B. An universal run flat tire system and device that can be installed in a tire and on a wheel rim to provide run flat capability for all types of vehicles including two wheel, four wheel or more and various embodiments of each, and their utility use forms;
a) a system and device that can be installed in all types of vehicle tires,
b) a system and device that can be installed in all types of tires without the tires being modified, changed or having the need for adapters to accommodate the multiplicity of tire configurations,
c) a system and device that can be installed on all sized vehicle rims, all rim configurations and has no limitations for device diametrical size and quantity to meet the various tire and rim configurations available,
d) a system and device that can be installed on any tire or rim and able to support the weight of the vehicle and run in the run or near run flat condition.
e) a system and device that provides the vehicle the capability to operate with or without air in the pneumatic tires on automobile, trucks, motorcycles, bicycles and their trailers or related functional operating vehicles having pneumatic tires,
f) a system and device that by changing only the shore hardness of the device can provide embodiments to achieve a soft ride or a hard ride to accommodate special uses or loads of the tires of a vehicle,
g) a system and device that by changing only the diameter and quantity of the device can provide embodiments to accommodate different vehicle operational loads,
h) a system and device that by changing both the various shore hardness and diameters of the device can accommodate different uses and operating loads.
